(19) United States
(12) Patent Application Publication
(10) Pub. No.: US 2017/0038143 A1
(43) Pub. Date: Feb. 9, 2017

(54) HORIZONTAL PADDLE DRYER

(71) Applicant: BRINOX, D.O.O., Medvode (SI)

(72) Inventor: Slavislav Savic, Ljubljana (SI)

(21) Appl. No.: 15/303,275

(22) PCT Filed: Apr. 7, 2015
(86) PCT No.: PCT/SI2015/000015

§ 371 Date: Oct. 11, 2016

(30) Foreign Application Priority Data
Apr. 7, 2014 (SI) P-201400132

(51) Int. Cl. F26B 11/16; B08B 3/02; B05B 15/08; F26B 25/04; F26B 25/16

(52) U.S. Cl. CPC F26B 11/16; F26B 25/04; F26B 25/16; B05B 15/08; B08B 3/02

(57) ABSTRACT

The object of the invention is a horizontal paddle dryer that is used for normal or vacuum drying of soaked substances that are in the form of dry powder mixtures or granulates in a manufacturing process and are soaked and mixed (normally with solvents) due to technological needs. Once drying is completed, the interior of the dryer needs to be washed due to various types of substances that differ from each other in content and properties. The construction of the horizontal paddle dryer of the invention allows simple and effective washing of the horizontal paddle dryer without an additional removal of washing heads during the washing of the dryer. The horizontal paddle dryer of the invention has a specially shaped interior wall (1) of the drum (2) that passes on the upper part through two surfaces (1a, 1b) that extend tangentially to the interior wall (1) into a horizontal final surface (1c) of the internal wall (1), such that a slightly concave part is created in the interior of the drum (2) in the wall (1), in which concave part retractable washing heads (3) are arranged that do not hinder functioning of the rotor (4) with paddles (5) either during drying or during washing.

The object of the invention is a horizontal paddle dryer that is used for normal or vacuum drying of soaked substances that are in the form of dry powder mixtures or granulates in a manufacturing process and are soaked and mixed (normally with solvents) due to technological needs. Once drying is completed, the interior of the dryer needs to be washed due to various types of substances that differ from each other in content and properties. The construction of the horizontal paddle dryer of the invention allows simple and effective washing of the horizontal paddle dryer without an additional removal and re-insertion of classic washing heads in all washing phases of the dryer. The invention is classified to Class F26B11/16 of the International Patent Classification.

The technical problem that is successfully solved by the present invention is a constructional solution to and an embodiment of the horizontal paddle dryer, especially of an inner wall—upper part of the dryer's drum that allows a simple and effective washing without a need to install washing heads before washing and the removal thereof after the washing in individual phases.

Horizontal paddle dryers are used for vacuum drying which is the most efficient method of drying for a majority of pharmaceutical, chemical and other, preferably food substances that are present in an industrial process in the form of dry powder mixtures or granulates and are soaked or mixed (usually with solvents) due to technological needs. Drying can also be carried out by an adequate combination of vacuum and temperature that causes evaporation of the solvent contained in a substance to be dried. Horizontal paddle dryers provide for homogeneous mixing of an inserted substance, a heat exchange factor is improved and this results in a reduced drying time.

The construction of horizontal paddle dryers consists of a substantially oblong empty cylindrical drum of a large round cross-section that is hermetically closed at one side by a cover. A rotor provided with paddles arranged at different places is arranged within the drum, said paddles allowing adequate mixing and advancement of the substance to be dried along a heated wall of the drum, wherewith the primary goal of a drying process is achieved—reduction of humidity of the inserted substance. Special shapes of the paddles of the rotor arranged within the horizontal paddle dryer provide for optimal heat exchange between a substance and the wall of the drier.

After drying of a mixture of powders or granulates that are soaked and mixed with solvents due to technological needs, the remains of the treated substance, solvents and other admixtures that remain after the removal of the treated substance need to be removed from the horizontal paddle dryer. The interior of the dryer (walls, edges, rotor paddles) need to be thoroughly washed. When cleaning the remains of pharmaceutical substances for instance, washing needs to be performed in following steps: washing with potable cold water, washing with detergents (once or twice), washing with potable cold water, washing with clean purified water, drying with hot pharmaceutical air.

Prior to washing the interior of known horizontal paddle dryers washing heads of any shapes must be installed and flanges are foreseen for this purpose on the circumference of the dryer's drum. The heads are removed during a drying procedure of the dryer since their installation would disturb a free rotation of the rotor with the paddles, whereas during a washing phase, i.e. in a non-operative phase of the rotor, the washing heads are inserted. The washing heads reach so far in the interior of the drum that rotation of the rotor with the paddles is made impossible during the washing. The washing heads are therefore arranged on the upper circumferential part of the drum in a way that a jet of a liquid does not reach all drum parts and the standing rotor with the paddles when washing is in course. Based on what has been described, the washing process in known embodiments of horizontal paddle dryers is very time consuming as the dryer needs to be prepared for washing each time separately (installation of the washing heads). Although several washing heads are installed they fail to reach all parts—surfaces of the interior of the drum (i.e. the not exposed surfaces of the paddles and the drum).

The horizontal paddle dryer of the invention does away with the drawbacks of known embodiments by a specially shaped drum, the interior wall of which does not have a perfectly round shape but an interior wall extends on the upper part through two surfaces that extend tangentially to the interior wall of the drum into a horizontal final part, such that a slightly concave part is created in the interior of the drum, in which retractable washing heads are arranged that do not hinder functioning of the rotor with paddles and need therefore not be removed during the functioning of the horizontal paddle dryer of the invention.

The invention will be explained in more detail by way of an embodiment and the enclosed drawings, on which

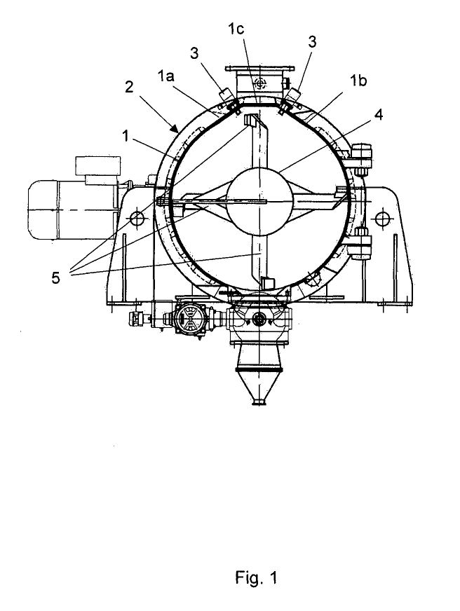

FIG. 1 shows a view of a horizontal paddle dryer of the invention without a front cover;

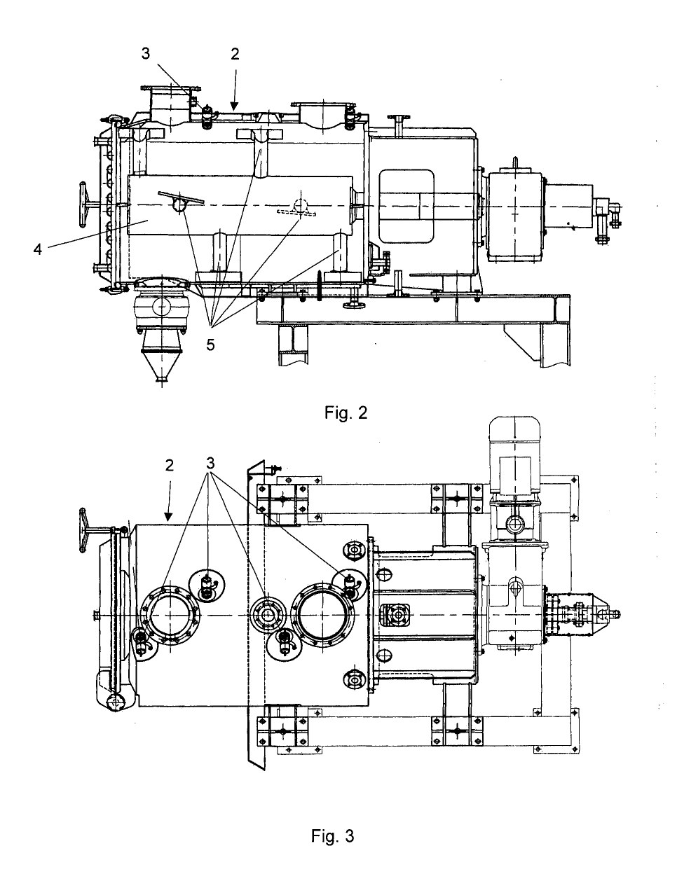

FIG. 2 shows a side view of a horizontal paddle dryer of the invention in partial cross-section;

FIG. 3 shows a top view of a horizontal paddle dryer of the invention.

A horizontal paddle dryer of the invention that is shown in the enclosed figures has an internal wall 1 of an oblong, substantially cylindrically shaped drum 2 that is reshaped at the top as shown in FIG. 1. The internal wall 1 passes from a round shape into two sections 1a, 1b that extend tangentially to the internal wall 1, said sections merging at the top with a horizontally arranged section 1c of the internal wall 1. A concave part of the internal wall 1 along the entire length of the drum 2 is thus created.

A rotor 4 with paddles 5 is arranged within the drum 2. It is evident from FIG. 1 that the paddles 4 which closely touch the internal wall 1 of the drum 2 do not touch the arranged retractable washing heads 3.

In this way a space is created at the top of the internal wall of the dryer of the invention that allows a permanent insertion of the retractable washing head 3 in the dryer's drum 2 in the area of sections 1a and 1b of the internal wall 1 without the heads disturbing the functioning of the dryer.

Due to the permanently inserted retractable washing heads 3 which are in a closed-tighten position during the drying phase and allow undisturbed operation of the dryer, washing of the interior of the drum 2 is simplified as the washing heads need not be inserted and removed in each individual washing phase. Besides, the rotor with the paddles can rotate during the washing and this provides for a more rapid and more effective washing of the horizontal dryer. Additionally, there are no covered surfaces that cannot be reached by the washing head during washing.

1. A horizontal paddle dryer, comprising:
a drum; and
a rotor with paddles arranged in the drum,
wherein a part of an internal wall of the drum is shaped in a concave way.

2. The horizontal paddle dryer according to claim 1, wherein the interior wall extends over the entire length of the drum on the upper part through two surfaces that extend tangentially to the interior wall into a horizontal final surface of the internal wall, such that a slightly concave part is created in the interior of the drum in the wall, in which concave part retractable washing heads are arranged that do not hinder functioning of the rotor with paddles.

3. The horizontal paddle dryer according to claim 1, wherein the retractable washing heads are arranged within the drum both in the drying phase and the washing phase.

4. The horizontal paddle dryer according to claim 2, wherein the retractable washing heads are arranged within the drum both in the drying phase and the washing phase.
